(19) United States
(12) Patent Application Publication
(10) Pub. No.: US 2014/0067355 A1
(43) Pub. Date: Mar. 6, 2014

(54) Using Haplotypes to Infer Ancestral Origins for Recently Admixed Individuals

(71) Applicant: Ancestry.com DNA, LLC, Provo, UT (US)

(72) Inventors: Keith D. Noto, San Francisco, CA (US); Jake Kelly Byrnes, San Francisco, CA (US); Catherine Ann Ball, Mountain View, CA (US); Kenneth Gregory Chahine, Park City, UT (US)

(73) Assignee: Ancestry.com DNA, LLC, Provo, UT (US)

(21) Appl. No.: 14/020,577

(22) Filed: Sep. 6, 2013

Related U.S. Application Data
(60) Provisional application No. 61/697,757, filed on Sep. 6, 2012.

(51) Int. Cl. G06F 19/12

(52) U.S. Cl. CPC G06F 19/12
USPC 703/11

(57) ABSTRACT

Phased haplotype features are used to infer an individual's ancestry. Reference genomic data is obtained for individuals of known ancestral origin. Haplotype features are identified based on consecutive SNPs from each individual. Sample genomic data is obtained for an individual of unknown ancestral origin. The data is phased and divided into features analogous to the features in the reference data. An admixture estimator then performs an admixture estimation based on the observed feature values in the sample data and the reference data. The estimation indicates a contribution of each of the known populations to the genome of the sample individual.

### CROSS-REFERENCE TO RELATED APPLICATIONS

This application claims the benefit of U.S. Provisional Application 61/697,757, filed on Sep. 6, 2012, which is incorporated by reference in its entirety.

### BACKGROUND

1. Field

The described embodiments relate generally to using genetic data to infer ancestral origins.

2. Description of Related Art

Although humans are, genetically speaking, almost entirely identical, small differences in our DNA are responsible for much of the variation between individuals. A variation of a single nucleotide at a single location can result in different traits, affect susceptibility to disease, and indicate a particular treatment. These locations where individual nucleotides vary among individuals are referred to as single nucleotide polymorphisms, or SNPs. As of late 2012, over 187 million SNPs have been found in the human genome out of a total genome length of about 3.2 billion base pairs.

SNPs have also been used to identify the ancestral origins of individuals—that is, the contribution of single-origin populations to the genome of the particular subject individual. This information is not only informative to the individual, but also useful for medical genetics and other fields. In many cases, methods that use SNP differences to assess ancestral origins assume marker independence, treating each SNP as an independent observation. With the advent of genotyping arrays in which millions of SNPs are typed, neighboring SNPs are frequently close enough to be in linkage disequilibrium (LD). In this case the alleles observed at neighboring SNPs are strongly correlated due to shared genetic history. Using this type of data requires LD thinning to remove linked pairs of SNPs and satisfy the independence assumption. Unfortunately LD thinning also removes significant amounts of information in the data, reducing assignment accuracy. This is particularly problematic in high resolution analyses, such as identifying countries of origin within Europe.

One method for estimating individual admixture is the FRAPPE method, described in Tang H, Peng J, Wang P, Risch N. 2005, “Estimation of Individual Admixture: Analytical and Study Design Considerations,” Genet Epidemiol 28: 289-301, incorporated by reference herein. Another is the ADMIXTURE method, described in D. H. Alexander, J. Novembre, and K. Lange. Fast model-based estimation of ancestry in unrelated individuals. Genome Research, 19:1655-1664, 2009, incorporated by reference herein.

### SUMMARY

Described embodiments use phased haplotype features for ancestry inference. Reference genomic data is obtained for individuals of known ancestral origin. Haplotype features are identified based on consecutive SNPs from each individual. The length of each feature is experimentally determined in various embodiments, and typically ranges from between two to 140 SNPs. In some embodiments, some consecutive SNPs are excluded from features to ensure that SNPs obtained through different methodologies (e.g., different chips) and included in features are available for at least most samples. Feature values are observed for each reference individual.

Sample genomic data is obtained for an individual of unknown ancestral origin. The data is phased and divided into features analogous to the features in the reference data.

An admixture estimator then performs an admixture estimation based on the observed feature values in the sample data and the reference data. The estimation indicates a contribution of each of the known populations to the genome of the sample individual.

### BRIEF DESCRIPTION OF THE DRAWINGS

FIG. 1 is a block diagram of a system for inferring ancestral origins of individuals in accordance with one embodiment.

FIG. 2 is a flow chart illustrating a method for obtaining feature values in accordance with one embodiment.

FIG. 3 is a flow chart illustrating a method for inferring ancestral origins of individuals in accordance with one embodiment.

### DETAILED DESCRIPTION

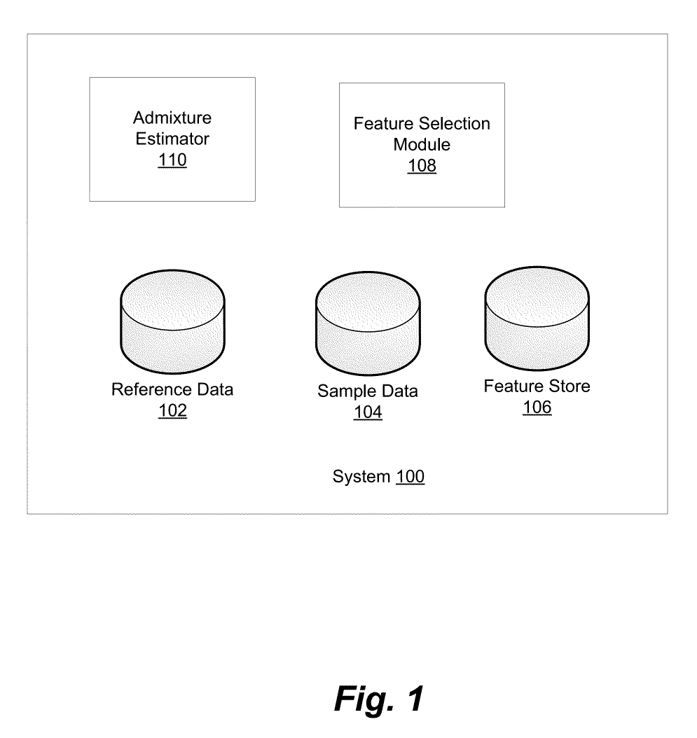

FIG. 1 is a block diagram of a system 100 for identifying ancestral origins of individuals in accordance with one embodiment. System 100 includes a reference data store 102, a sample data store 104, a feature store 106, a feature selection module 108 and an admixture estimator 110. Each of these components is described further below.

System 100 may be implemented in hardware or a combination of hardware and software. For example, system 100 may be implemented by one or more computers having one or more processors executing application code to perform the steps described here, and data may be stored on any conventional storage medium and, where appropriate, include a conventional database server implementation. For purposes of clarity and because they are well known to those of skill in the art, various components of a computer system, for example, processors, memory, input devices, network devices and the like are not shown in FIG. 1.

Reference data store 102 stores reference genotype data for individuals with known ancestry. In one embodiment, reference data is stored for multiple populations of known single origins, for example as identified by the International HapMap Consortium. See, e.g., The International HapMap3 Consortium, “Integrating common and rare genetic variation in diverse human populations.” Nature 2010 Sep; 467(2):52-58, incorporated by reference herein. In alternative embodiments, the reference genotypes are not from single origin populations, but the ancestry of each individual in the reference population is known. Data sets for single-origin individuals are widely available, including through the NCBI database of Genotypes and Phenotypes (dbGaP). See, e.g., Nelson M R et al., “The Population Reference Sample, POPRES: a resource for population, disease, and pharmacological genetics research.” Am J Hum Genet. 2008 Sep; 83(3):347-58., incorporated by reference herein.

Reference data stored in reference data store 102 is, in various embodiments, phased to allow haplotypes to be inferred. Phasing may be performed through a conventional method such as the BEAGLE method described in S R Browning and B L Browning (2007), “Rapid and accurate haplotype phasing and missing data inference for whole genome association studies using localized haplotype clustering.” Am J Hum Genet 81:1084-1097, incorporated by reference herein.

We refer to a set of SNPs that are in consecutive locations on a chromosome as a haplotype feature, or simply a feature. Each feature has multiple possible feature values depending on the particular SNP values at each location in the feature. For example, for a feature that is five SNPs in length, and assuming two typically observed SNP values at each locus, there are 2⁵=32 possible feature values for that feature.

In one embodiment, some SNPs are excluded from selection as being part of a feature if the SNP data at a particular locus is not available across all of the reference sets, for example because different chips have been used for different reference sets.

In various embodiments, system 100 uses features of different lengths to infer ancestral origin. By varying the feature length used, an optimum feature length can be experimentally determined. In one embodiment, feature length is selected by obtaining ancestral origin estimates for individuals in the reference set according to the methods described here using features of different length for each trial. The feature length that provides the most accurate estimate is then selected as the feature length for identifying ancestral origins from unknown samples. Ranges of feature length that may provide informative estimates of ancestral origin include in various embodiments from two SNPs to 140 SNPs.

In various embodiments, features of different lengths may be chosen within the genome. For example, in one embodiment feature lengths are selected based on known recombination distances such that each feature includes approximately the same number of centimorgans. In another embodiment, feature lengths are selected based on absolute chromosome distance (i.e., difference between starting and ending chromosome nucleotide positions defining the feature). In yet another embodiment, feature lengths are selected based on the number of included SNPs.

Once the feature lengths are selected, features are identified and in one embodiment their loci are stored in feature store 106.

### Building the Reference Data Set

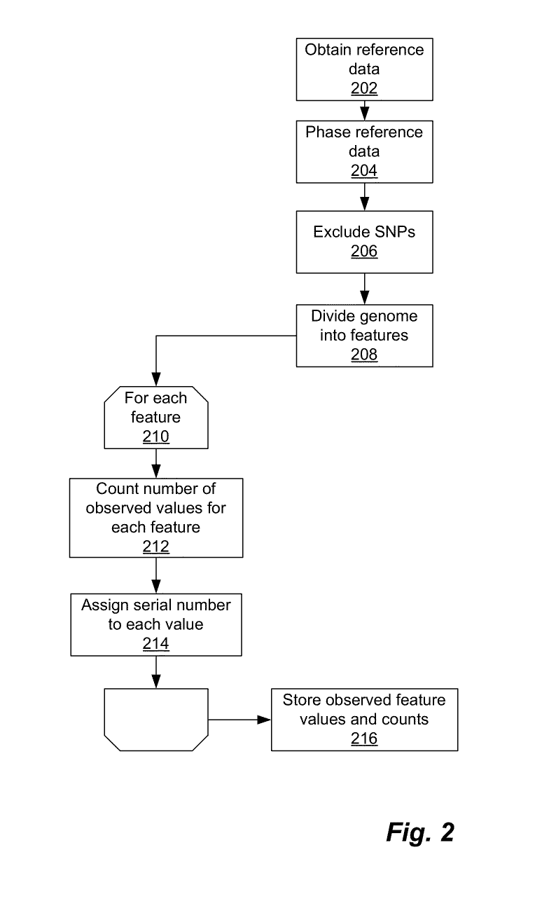

In one embodiment, and referring now to FIG. 2, once the reference data has been obtained 202 and, if necessary, phased 204; some SNPs have been excluded 206 if needed; and the phased haplotype has been grouped 208 into features of the set length; feature selection module 108 reads reference data from reference data store 102 and, for each feature 210, determines 212 which values are observed for each feature in the reference data sets. In one embodiment, each observed feature value is assigned 214 an identifier, which could be, for example, a sequential number, to represent the feature value in an abbreviated fashion. A mapping from each identifier to the feature value is maintained in one embodiment in feature store 106. Since the ancestral history of each reference sample is known, the relationship between particular feature values and ancestral origin can be inferred. The observed features from the reference data are stored 216 in feature store 106.

### Preparing the Query Data

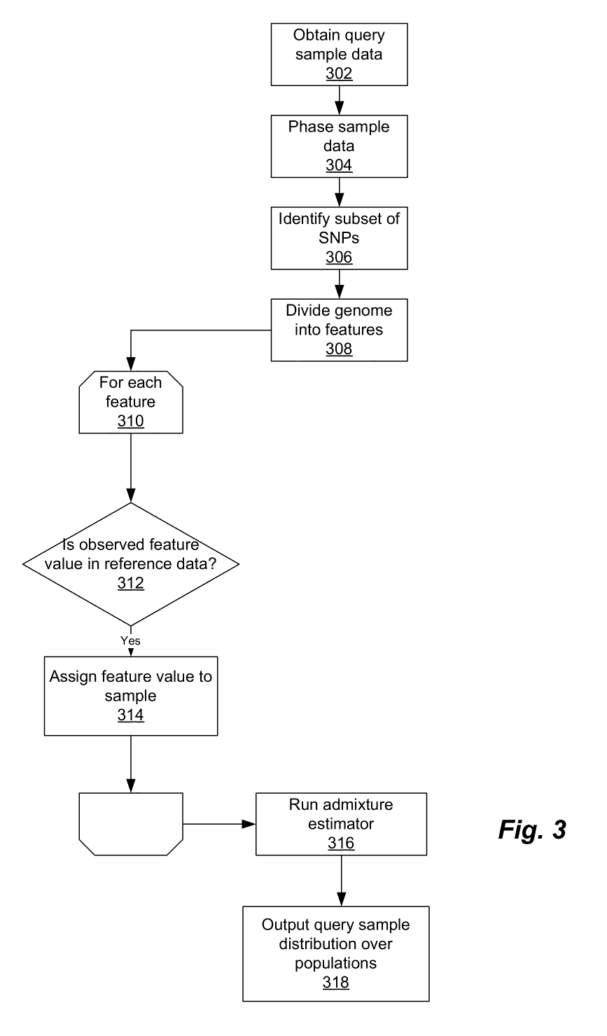

Referring to FIG. 3, obtained 302 sample data, e.g., genomic data from an individual of unknown ancestral origin, is stored in sample data store 104. As with the reference data, the sample data is in various embodiments either already phased or undergoes 304 a phasing so that it can be further analyzed. In various embodiments a subset of the SNPs in the sample data is selected 306 to match the SNPs available in reference data store 102.

Feature selection module 108 then divides 308 the sample genome into features. As described above with respect to the reference set, the length of each feature may be experimentally determined and may optimally have different values depending on the number of and particular types of reference populations being compared. Feature selection module 108 then reads the feature values of the sample data and for each feature 310 if 312 the observed feature value is in the reference data, associates 314 the values with the feature value identifiers determined for each observed value in the reference data set. For example, in one embodiment feature store 106 includes a mapping from a feature value to an identifier, and a flag or other counter is set by feature selection module 108 for each feature value identified in the sample data. This results in a set of feature value identifiers present in the sample data set.

In one embodiment, only feature values that appear in the reference set more than a threshold number of times or frequency are included in feature store 106. This reduces a likelihood of an incorrect inference based on a feature value present in the sample data that is present but not significant in the reference data. The threshold number may be determined experimentally and may be, for example, 1%, 5% or 10%, or any other value desired by the implementer.

Following assignment of feature value data to the sample set, the admixture estimation algorithm is then run 316.

### Frappe

Admixture estimator 110 analyzes the feature values from the sample data and the reference data to determine a population assignment for the sample data. In one embodiment, admixture estimator 110 uses a modified version of the FRAPPE iterative expectation maximization (E-M) algorithm to score the observed feature values.

In one embodiment, admixture estimator 110 uses the following equations to determine the contribution qᵢₖ of a population k to individual i's genome based on J features (indexed 1, 2, 3, . . . J) and I=n+1 individuals (including n individuals in the reference panels plus the query sample individual). Feature value h of feature j has frequency fⱼₖₕ in population k, and g_{cijh} takes on the value 1 if the feature value observed for feature j in copy c of individual i's phased chromosomes is h, and 0 otherwise.

$${f}_{jkh}^{n + 1} = \frac{{\sum }_{i}^{ } {\sum }_{c}^{ } {g}_{cijh} \frac{{q}_{ik}^{n} {f}_{jkh}^{n}}{{\sum }_{m}^{ } {q}_{im}^{n} {f}_{jmh}^{n}}}{{\sum }_{i}^{ } {\sum }_{v}^{ } {\sum }_{c}^{ } {g}_{cijv}}$$

$${q}_{ik}^{n + 1} = \frac{1}{J} {\sum }_{j}^{ } {\sum }_{h}^{ } {\sum }_{c}^{ } {g}_{cijh} \frac{{q}_{ik}^{n} {f}_{jkh}^{n}}{{\sum }_{m}^{ } {q}_{im}^{n} {f}_{jmh}^{n}}$$

In the above equations, feature values can take on any observed haplotype value. qᵢₖⁿ refers to the value qᵢₖ in iteration n of the E-M algorithm, and the same superscript notation applies to fⱼₖₕ.

Admixture estimator 110 determines the contributions qᵢₖ and for each individual outputs the determined contributions to a file, output device, network device, or the like. In various embodiments the data for individual sample determinations is stored, e.g., in sample data store 104, and provided as individual or batched records periodically or on demand to a requestor or reporting system.

### Unsupervised Version

In one embodiment, system 100 does not use reference data based on individuals of known ancestral origin. Instead, multiple sample data sets are obtained from genomes having k total ancestral population origins. The genomes are divided into features as described above, and admixture estimator 110 performs a cluster analysis to group to identify the contribution of each of the k populations to each sample data set.

Admixture estimator 110 can also use an algorithm based on ADMIXTURE to infer ancestral origin. In various embodiments, feature store 106 includes a mapping of each observed feature value for each feature to a new set of binary haplotype features that can serve as inputs to the existing ADMIXTURE software. To create binary haplotype features, admixture estimator 110 proceeds as follows. For each haplotypic feature j, let vⱼ be the number of observed values. Admixture estimator 110 adds vⱼ new features to the set of binary features. Call these new features b₁, b₂, . . . bᵥⱼ. For each new binary feature admixture estimator 110 sets its value for individual i to 1 if and only if individual i has the feature value corresponding to serial number l for feature j (otherwise 0).

Within this written description, the particular naming of the components, capitalization of terms, the attributes, data structures, or any other programming or structural aspect is not mandatory or significant unless otherwise noted, and the mechanisms that implement the described invention or its features may have different names, formats, or protocols. Further, the system may be implemented via a combination of hardware and software, as described, or entirely in hardware elements. Also, the particular division of functionality between the various system components described here is not mandatory; functions performed by a single module or system component may instead be performed by multiple components, and functions performed by multiple components may instead be performed by a single component. Likewise, the order in which method steps are performed is not mandatory unless otherwise noted or logically required. It should be noted that the process steps and instructions of the present invention could be embodied in software, firmware or hardware, and when embodied in software, could be downloaded to reside on and be operated from different platforms used by real time network operating systems.

Algorithmic descriptions and representations included in this description are understood to be implemented by computer programs. Furthermore, it has also proven convenient at times, to refer to these arrangements of operations as modules or code devices, without loss of generality.

Unless otherwise indicated, discussions utilizing terms such as “selecting” or “computing” or “determining” or the like refer to the action and processes of a computer system, or similar electronic computing device, that manipulates and transforms data represented as physical (electronic) quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented are not inherently related to any particular computer or other apparatus. Various general-purpose systems may also be used with programs in accordance with the teachings above, or it may prove convenient to construct more specialized apparatus to perform the required method steps. The required structure for a variety of these systems will appear from the description above. In addition, a variety of programming languages may be used to implement the teachings above.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for determining an ancestral origin of a subject, the ancestral origin including multiple single-origin populations, the method comprising:
obtaining a subject sample data set, the data set including observed values for a plurality of haplotype features in the genome of the subject;
modeling, by a computer, the frequency of each haplotype feature value in a plurality of reference sets including a plurality of known populations;
modeling, by the computer, the contribution of each ancestral population to the genome of each individual in the query set;
iteratively updating, by the computer, the modeled contribution; and
outputting an estimated contribution of each of the populations to the genome of the subject.

2. The method of claim 1 wherein only observed features occurring in at least one reference set with at least a threshold frequency are included in the modeling.

3. The method of claim 1 wherein the reference sets include haplotype feature values from single-origin populations.

4. The method of claim 1 wherein the reference sets include haplotype feature values from admixed populations of known origin.

5. The method of claim 1 wherein each haplotype feature consists of a plurality of single nucleotide polymorphisms.

6. The method of claim 5 wherein the plurality includes between 2 and 140 single nucleotide polymorphisms.

7. The method of claim 5 wherein the plurality of single nucleotide polymorphisms are consecutive along a chromosome.

8. A method for determining an ancestral origin of a subject, the ancestral origin including multiple single-origin populations, the method comprising:
obtaining a plurality of data sets, each data set including observed values for a plurality of haplotype features from an individual genome, each feature including a plurality of consecutive single nucleotide polymorphisms;
performing a cluster analysis on the data sets according to the observed feature values; and
associating, based on the cluster analysis, at least one of the single-origin populations to each of the data sets.

9. The method of claim 8 wherein associating the single origin population to the data sets further comprises estimating a proportion of each data set originating from the single origin population.

10. A computer program product for determining an ancestral origin of a subject, the ancestral origin including multiple single-origin populations, computer program product stored on a non-transitory computer readable medium and including program code adapted to cause a processor to execute the steps of:
obtaining a subject sample data set, the data set including observed values for a plurality of haplotype features in the genome of the subject;
modeling the frequency of each haplotype feature value in a plurality of reference sets including a plurality of known populations;
modeling the contribution of each ancestral population to the genome of each individual in the query set;
iteratively updating the modeled contribution; and
outputting an estimated contribution of each of the populations to the genome of the subject.

11. The computer program product of claim 10 wherein only observed features occurring in at least one reference set with at least a threshold frequency are included in the modeling.

12. The computer program product of claim 10 wherein the reference sets include haplotype feature values from single-origin populations.

13. The computer program product of claim 10 wherein the reference sets include haplotype feature values from admixed populations of known origin.

14. The computer program product of claim 10 wherein each haplotype feature consists of a plurality of single nucleotide polymorphisms.

15. The computer program product of claim 14 wherein the plurality includes between 2 and 140 single nucleotide polymorphisms.

16. The computer program product of claim 14 wherein the plurality of single nucleotide polymorphisms are consecutive along a chromosome.
